(19) United States
(12) Patent Application Publication
(10) Pub. No.: US 2007/0268710 A1
(43) Pub. Date: Nov. 22, 2007

(54) Lighting Clip

(76) Inventor: Krzysztof Skiba, Bielsko-Biala (PL)

Correspondence Address: POWER DEL VALLE LLP, 233 WEST 72 STREET, NEW YORK, NY, 10023, US

(21) Appl. No.: 10/596,284

(22) PCT Filed: Dec. 2, 2004
(86) PCT No.: PCT/PL04/00099

§ 371 Date: Jun. 8, 2006

(30) Foreign Application Priority Data
Dec. 11, 2003 (PL) P.364017

(51) Int. Cl. F21V 21/088

(52) U.S. Cl. 362/396

(57) ABSTRACT

The object of the invention is a lighting clip used as backlighting of transparent or semi-transparent materials in the form of glass or plastic panes, in particular, glass shelves in a display cabinet or glass desk and table tops. The lighting clip fixed around an edge of a transparent or semi-transparent panel in a removable or permanent way and supplied by an electric power system, characterised by the fact that it is in the form of a section (1), with at least one side open, built of clamping arms (2) and (3) joined with a connector (4) and equipped with at least one source of light (6) placed in the internal space (5).

The object of the invention is a lighting clip used as backlighting of transparent or semi-transparent materials in the form of glass or plastic panes, in particular, glass shelves in a display cabinet or glass desk and table tops.

To date, backlighting of transparent or semi-transparent materials in the form of panels used for shelves or table/desk tops has been achieved by using special construction battens fixed to their edges, where light, emitted by its source comes through holes bored in the battens.

There are also devices known, used for backlighting of transparent or semi-transparent materials in the form of panels, built of a source of light accompanied by a mirror that reflects light beams, directing the light directly at the edge of the backlit panel. Those devices usually require a relatively large surface for their fixing and they are of considerable sizes.

The lighting clip according to the invention, fixed around an edge of a transparent or semi-transparent panel in a removable or permanent way and supplied by an electric power system, is characterised by the fact that it is in the form of a section, with at least one open side, built of clamping arms joined with a connector and equipped with at least one source of light placed in the internal space. The section is in the form of a self-supporting elastic shape, open on one side, which consists of clamping arms of different length, where one of the arms is diagonal to the external panel surface or the section is in the form of a self-supporting elastic shape, open on one side, which consists of clamping arms of equal length, where both arms are diagonal to the panel surface or the section is in the form of a shape, open on one side, which consists of two clamping arms which are parallel.

The object of the invention has been presented as the example product shown in the drawing, where

FIG. 1 presents the top view of the lighting clip fixed on an edge of a glass shelf;

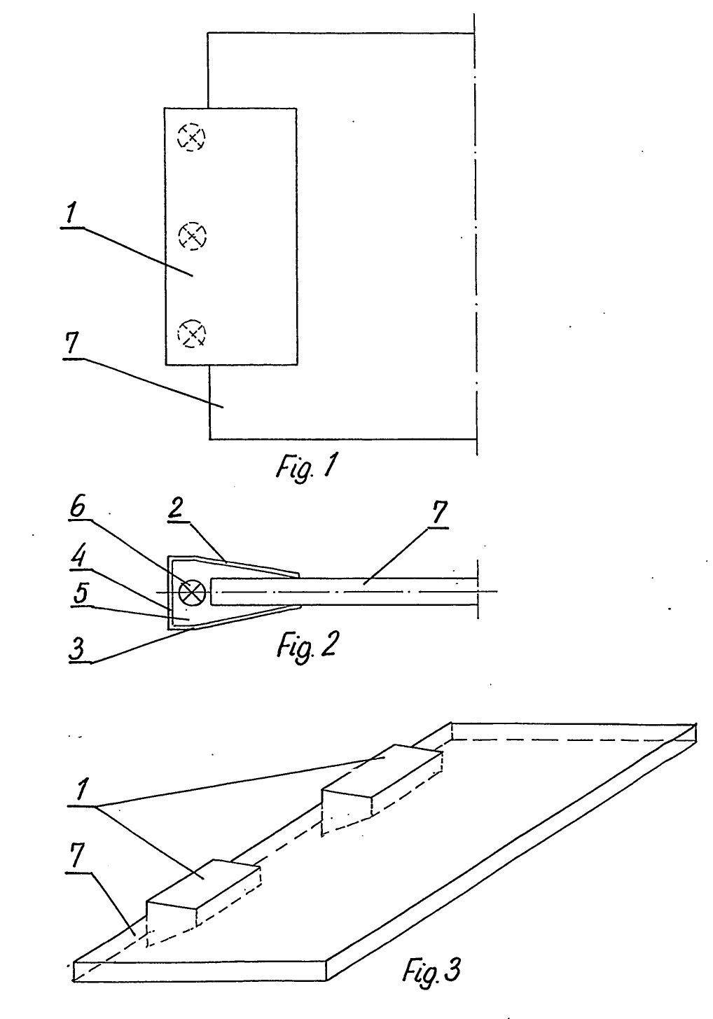

FIG. 2 presents the side view of the lighting clip of a section consisting of two diagonal arms of equal length, fixed on an edge of a glass shelf;

FIG. 3 presents an axonometric view of a glass shelf with two lighting clips with a section built of two diagonal arms of equal length fixed on one of the shelf sides;

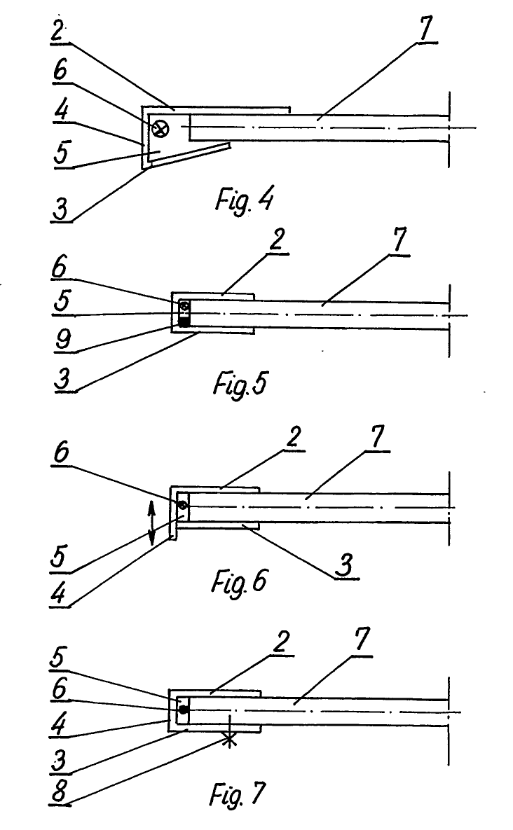

FIG. 4 presents the side view of the lighting clip of a section consisting of two diagonal arms of different length, fixed on an edge of a glass shelf;

FIG. 5 presents the side view of the lighting clip of a section consisting of two fixed parallel arms, permanently assembled on an edge of a glass shelf;

FIG. 6 presents the side view of the lighting clip of a section consisting of two parallel arms, where one of them is movable, permanently fixed on an edge of a glass shelf; and

FIG. 7 presents the side view of the lighting clip of a section consisting of two parallel arms, where one of them is movable and fixed with a screw, assembled on an edge of a glass shelf in a removable way.

As it is presented in the drawing, the lighting clip is in the form of a shape 1 open on one side, built of clamping arms 2 and 3 joined by a connector 4 and provided with at least one source of light 6 placed in its internal space 5. The clamping arms 2 and 3 can be in linear or surface contact with the surface of a panel 7, while they can be connected with that panel 7 in a removable way—using a screw 8 or in a fixed way—using a glue 9.

The lighting clip provided with the source of light 6 is assembled around the edge of the panel 7 using the elasticity force of the material used for the arms 2 and 3, as it is presented in FIGS. 2 and 4; or the clip can be assembled on the surface of the panel 7 in a fixed way, as it is presented in FIG. 5; or it can be assembled on the surface of the panel 7 in a removable way, as it is presented in FIGS. 6 and 7. Depending on the requirements, in order to achieve the desired result of backlighting of the panel 7, after supplying electric power to the sources of light 6, one or a few lighting clips can be assembled on an edge of the panel 7.

Patent claims:

1. A lighting clip fixed around an edge of a transparent or semi-transparent panel in a removable or permanent way, and supplied by an electric power system, characterised by the fact that it is in the form of a section (1), with at least one side open, built of clamping arms (2) and (3) joined with a connector (4) and equipped with at least one source of light (6) placed in the internal space (5).

2. The clip, according to claim 1, characterised by the fact that the section (1) is in the form of an elastic, self-supporting shape, open on one side, consisting of clamping arms (2) and (3) of different length, where one of the arms is diagonal to the external surface of the panel (7).

3. The clip, according to claim 1, characterised by the fact that the section (1) is in the form of an elastic, self-supporting shape, open on one side, consisting of clamping arms (2) and (3) of equal length, where both arms (2) and (3) are diagonal to the surface of the panel (7).

4. The clip, according to claim 1, characterised by the fact that the section (1) is in the form of a shape, open on one side, consisting of clamping arms (2) and (3) where both arms (2) and (3) are parallel.
